(19) United States
(12) Patent Application Publication
(10) Pub. No.: US 2007/0035175 A1
(43) Pub. Date: Feb. 15, 2007

(54) Hub for a bicycle

(76) Inventor: Yen-Jiun Lin, Changhua County (TW)

Correspondence Address: CHARLES E. BAXLEY, ESQ., 90 JOHN STREET, THIRD FLOOR, NEW YORK, NY, 10038, US

(21) Appl. No.: 11/200,760

(22) Filed: Aug. 9, 2005

(51) Int. Cl. B60B 1/02

(52) U.S. Cl. 301/55

(57) ABSTRACT

A hub for a bicycle comprises a flange formed at either side thereof, in the flanges are annularly formed a plurality of apertures through which a plurality of spokes are inserted and connected to a rim. On an axial surface of the hub are formed a plurality of locking holes that are located between the flanges of the hub for securing an end of the spokes, another end of the respective spokes is secured to the rim, so that the spokes between the hub and the rim are tensioned evenly and properly and can be prevented from inappropriate deformation, and accordingly the bicycle can run more safely.

### BACKGROUND OF THE INVENTION

1. Field of the Invention

The present invention relates to a bicycle, and more particularly to a hub of a bicycle.

2. Description of the Prior Art

Referring to FIG. 1, which is an exploded view of showing a conventional hub 11, a plurality of spokes 13 and a part of a rim 12. The spokes 13 are inserted in the apertures 112 on the hub flange 111 of the hub 11 in such a manner that the head 131 of the respective spokes 13 is locked in the apertures 112 on the hub flange 111 and the threaded end 132 of the spokes 13 is inserted through the apertures 121 on the rim 12 and is locked at the rim of the rim 12 by the spoke nipples 14.

This type hub has appeared on the market for a long time, however, it still has some disadvantages that need to be improved, with reference to FIG. 2:

First, when the rider is riding the bicycle, the spokes 13 have to support the weight of the bicycle and the rider, the load applied on the spokes 13 is very large. Therefore, the spokes 13 are more susceptible to deformation after a certain period of use, so that the rim 12 will rotate about the hub 11 in an oscillating manner, and this will make it difficult for the rider to control the bicycle.

Second, after the spokes 13 are locked in the apertures 112 in the hub flange 111 of the hub 11, and then are locked alternatively in the respective apertures 121 of the rim 12 (the apertures 121 are alternatively arranged on the inner surface of the rim 12 and located close to the left and right edge of the inner surface of the rim 12). When one of the spokes 13 is deformed, the other spokes 13 also will not be fully tensioned, and thus the spokes 13 will more easily be deformed.

Third, the spokes for the mountain bike are more susceptible to deformation due to the mountain bike often runs on the bad road full of holes and pumps, therefore, the mountain bike needs more maintenance for the sake of safety, and thus the maintenance fee is increased.

The present invention has arisen to mitigate and/or obviate the afore-described disadvantages.

### SUMMARY OF THE INVENTION

The primary objective of the present invention is to provide a hub for a bicycle such that the spokes between the hub and the rim are tensioned evenly and properly and can be prevented from inappropriate deformation, and accordingly the bicycle can run more safely.

A hub for a bicycle comprising a flange formed at either side thereof, in the flanges are annularly formed a plurality of apertures through which a plurality of spokes are inserted and connected to a rim;

on an axial surface of the hub are formed a plurality of locking holes that are located between the flanges of the hub for securing an end of the spokes, another end of the respective spokes is secured to the rim.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of showing a conventional hub, a plurality of spokes and a part of a rim;

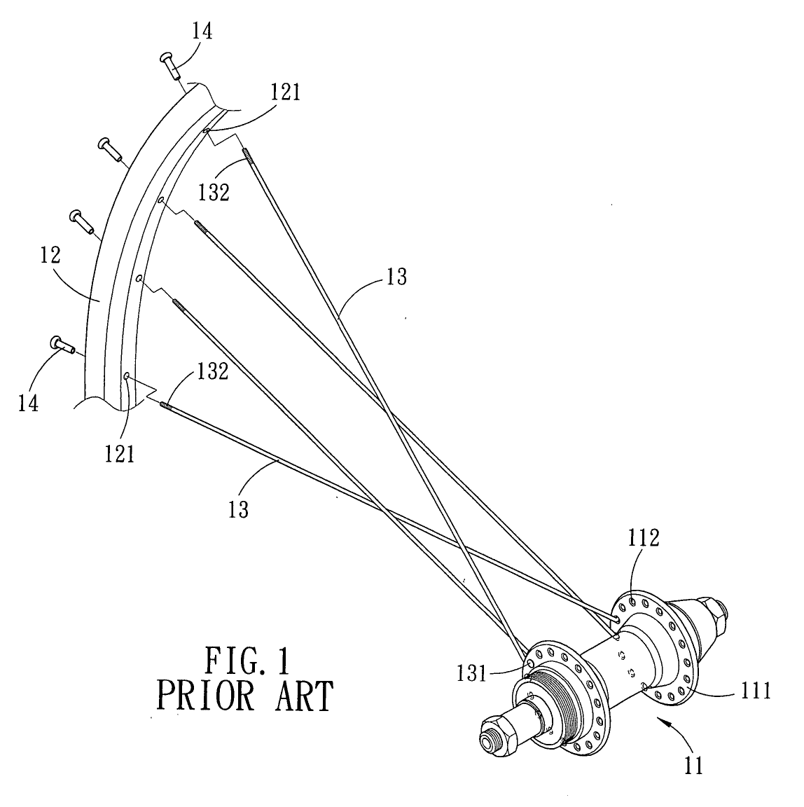

FIG. 2 is an assembly cross sectional view of FIG. 1;

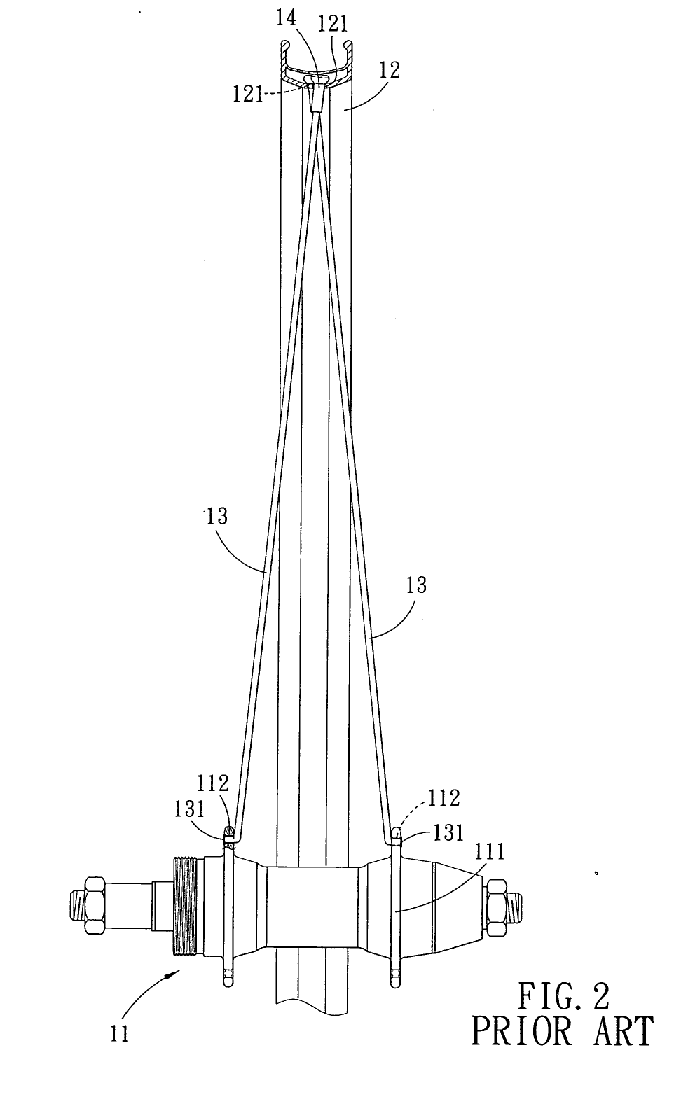

FIG. 3 is an exploded view of showing a hub, a plurality of spokes and a part of a rim in accordance with the present invention;

FIG. 4 is an assembly view of FIG. 3;

FIG. 5 is a cross sectional view in accordance with the present invention of showing the hub being connected with the rim by spokes;

FIG. 6 is a cross sectional view in accordance with another embodiment of the present invention of showing the hub being connected with the rim by spokes.

### DETAILED DESCRIPTION OF THE PREFERRED EMBODIMENTS

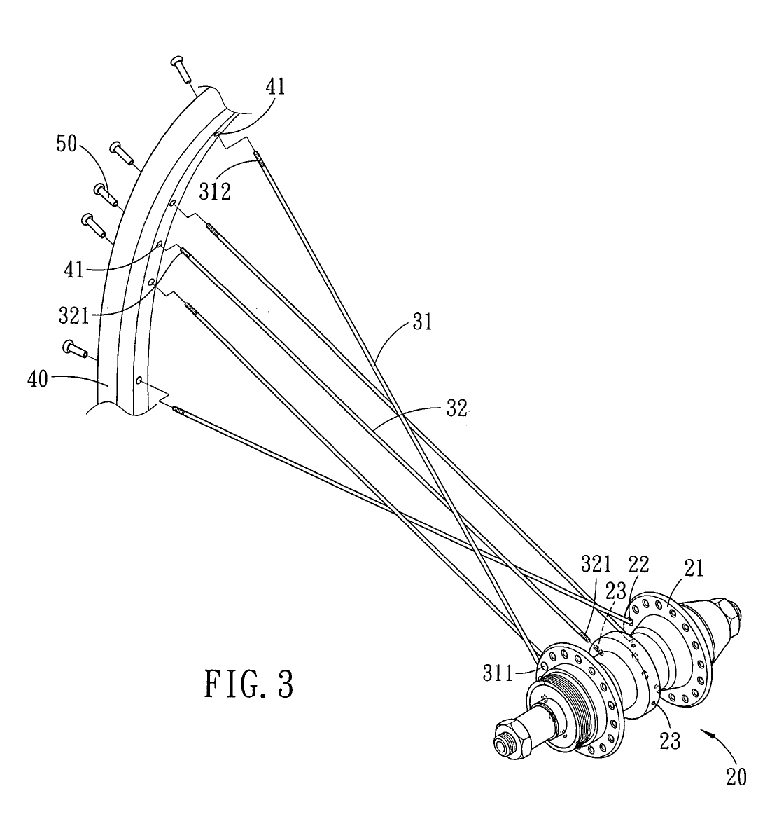

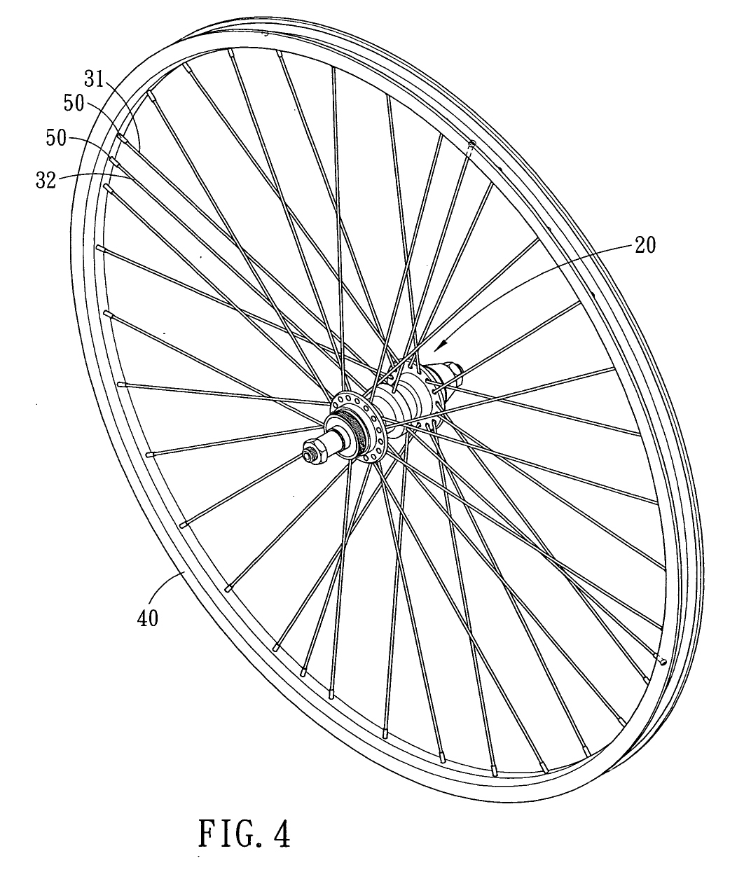

Referring to FIGS. 3 and 4, which show a hub 20, a plurality of spokes 31, 32, a rim 40 and a plurality of spoke nipples 50.

The hub 20 is provided at either side thereof with a flange 21 on which are formed a plurality of apertures 22, and on the axial surface of the hub 20 are formed a plurality of locking holes 23 that are located between the flanges 21.

The spokes 31 each has a head 311 and a threaded end 312, the head 311 of the spokes 31 is locked at the edge of the apertures 22 after the threaded end 312 is inserted through the apertures 22. The spokes 32 each has two threaded ends 321 and one of the threaded ends 321 is screwed in the locking holes 23 of the hub 20.

The rim 40 is formed on its inner periphery with a plurality of apertures 41 that are arranged close to the left, right edges and mid portion of the inner periphery of the rim 40 in an alternative manner. The spokes 31 are arranged in pairs and cross each other in such a manner that the head 311 is hooked to the aperture 22 of the flange 21 of the hub 20 and the threaded ends 312 of the respective spokes 31 are inserted in the apertures 41 close to the left and right edges of the rim 40. The other one of the threaded ends 321 of the respective spokes 32 is secured to the apertures 41 in the mid of the rim 40.

The spoke nipples 50 are screwed to the threaded ends 312 and 321 of the spokes 31 and 32, respectively, and are anchored at the peripheral edge of the apertures 41 of the rim 40.

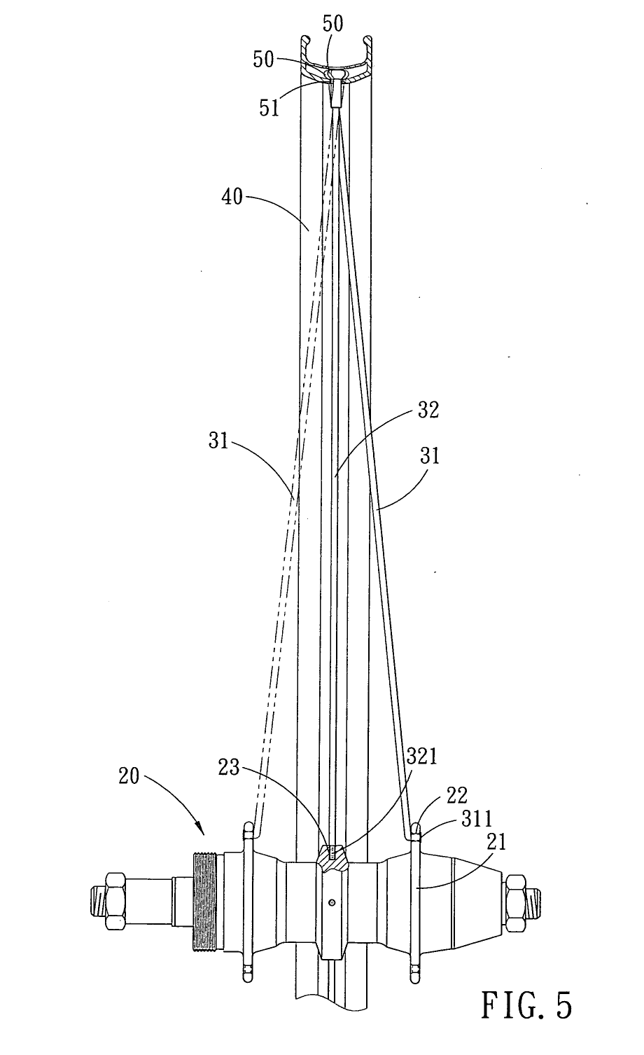

For a better understanding of the present invention, its operation and function, reference should be made to FIG. 5, the two threaded ends 321 of the respective spokes 32 are screwed in the locking holes 23 in the axial surface of the hub 20 and secured to the apertures 41 at the mid portion of the rim 40 by spoke nipples 50, respectively.

By such arrangements, an additional number of spokes 32 can be arranged between the hub 20 and the rim 40 for strengthening the connecting strength therebetween, so that the spokes 31 and 32 can be tensioned evenly and can be prevented from inappropriate tension.

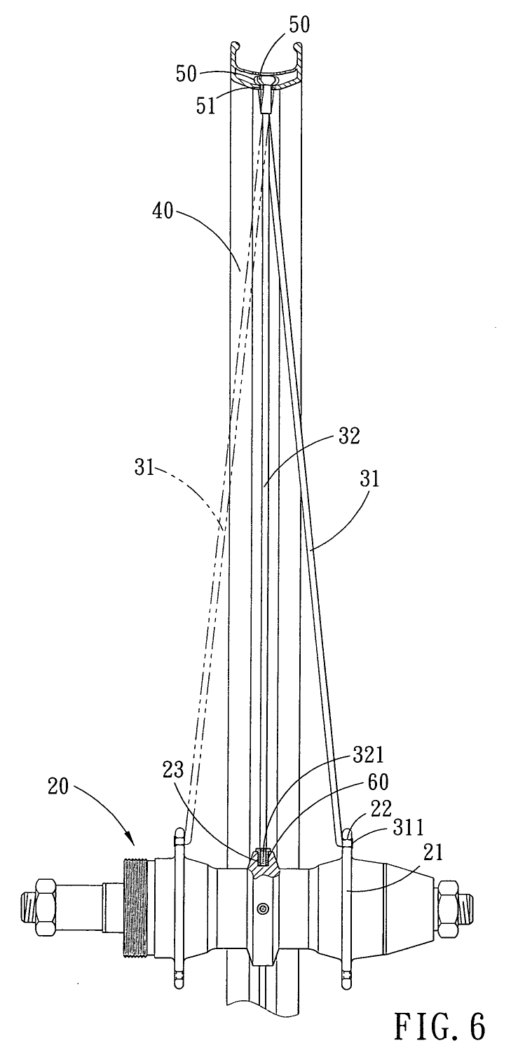

Referring to FIG. 6, a hub structure in accordance with another embodiment of the present invention is shown and is similar to that of the previous embodiment, except that:

In the locking holes 23 of the hub 20 is secured a T-shaped connecting tube 60, on the inner and outer periphery of the connecting tube 60 are formed with threads for screwed with the spokes 32 and the rim 40, respectively.

While we have shown and described various embodiments in accordance with the present invention, it should be clear to those skilled in the art that further embodiments may be made without departing from the scope of the present invention.

What is claimed is:

1. A hub for a bicycle comprising a flange formed at either side thereof, in the flanges are annularly formed a plurality of apertures through which a plurality of spokes are inserted and connected to a rim;
on an axial surface of the hub are formed a plurality of locking holes that are located between the flanges of the hub for securing an end of the spokes, another end of the respective spokes is secured to the rim.

2. The hub for a bicycle as claimed in claim 1, wherein a plurality of T-shaped connecting tubes is secured in the locking holes, for connecting the spokes and the rim.
